(19) United States
(12) Patent Application Publication
(10) Pub. No.: US 2009/0209439 A1
(43) Pub. Date: Aug. 20, 2009

(54) ACIDIZING TREATMENT COMPOSITIONS AND METHODS

(75) Inventors: Xiangdong Willie Qiu, Dhahran (SA); Fakuen F. Chang, Al-Khobar (SA); Gary Tustin, Sawston (GB)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 12/032,156

(22) Filed: Feb. 15, 2008

(51) Int. Cl. C09K 8/72

(52) U.S. Cl. 507/267

(57) ABSTRACT

A reservoir treatment fluid is described being a hydrochloric acid and a compound forming a carboxylic acid within a well penetrating a subterranean reservoir.

### FIELD OF THE INVENTION

The invention relates to compositions for and methods of treating subterranean reservoirs, particularly hydrocarbon reservoirs. More specifically, the invention pertains to methods and compositions for acid treatment of hydrocarbon reservoirs, particularly carbonate reservoirs.

### BACKGROUND

Hydrocarbons (oil, natural gas, etc.) are typically obtained from a subterranean geologic formation (i.e., a “reservoir”) by drilling a well that penetrates the hydrocarbon-bearing formation. In order for hydrocarbons to be “produced”, that is, travel from the formation to the wellbore (and ultimately to the surface), there must be a sufficiently unimpeded flowpath from the formation to the wellbore. This flowpath is through the formation rock, e.g., solid carbonates or sandstones having pores of sufficient size, connectivity, and number to provide a conduit for the hydrocarbon to move through the formation.

Recovery of hydrocarbons from a subterranean formation is known as “production.” One key parameter that influences the rate of production is the permeability of the formation along the flowpath that the hydrocarbon must travel to reach the wellbore. Sometimes, the formation rock has a naturally low permeability; other times, the permeability is reduced during, for instance, drilling the well. When a well is drilled, a drilling fluid is often circulated into the hole to contact the region of a drill bit. This drilling fluid can be lost by leaking into the formation. To prevent this, the drilling fluid is often intentionally modified so that a small amount of its liquid content leaks off and the remaining solid content forms a coating on the wellbore surface (often referred to as a “filtercake”). Once drilling is complete, and production is desired, this coating or filtercake must be removed to re-establish the flowpath from the formation into the well.

Further changes to the permeability occur during the production phase of the well, as water containing a number of dissolved salts is often coproduced with the hydrocarbon. Especially when the formation is a carbonate, calcium cations are prevalent, as are carbonate and phosphate anions. The combination products of calcium cation with carbonate anion or phosphate anion will precipitate from the water in which the ions are carried to form “scale” deposits when the concentrations of these anions and cations exceed the solubility of the reaction product. The formation of scale can slow oil production rate and, in extreme circumstances, stop production completely. Scale built-up is thus another reason for treating formations.

Formation treatments and well operations used to increase the net permeability of the reservoir are generally referred to as “stimulation” techniques. Typically, stimulation techniques include methods such as: (1) injecting chemicals into the wellbore to react with and dissolve the damage (e.g., scales, filtercakes); (2) injecting chemicals through the wellbore and into the formation to react with and dissolve small portions of the formation to create alternative flowpaths for the hydrocarbon; and (3) injecting chemicals through the wellbore and into the formation at pressures sufficient to actually fracture the formation, thereby creating a large flow channel through which hydrocarbon can more readily move from the formation into the wellbore.

In particular, it is known to enhance the productivity of hydrocarbon wells (e.g., oil wells) by removing (by dissolution) near-wellbore formation damage or by creating alternate flowpaths by fracturing and dissolving small portions of the formation at the fracture face. These variants of a stimulation operation are known as “matrix acidizing,” and “acid fracturing”, respectively. Generally speaking, acids, or acid-based fluids, are useful for these stimulation operations due to their ability to dissolve both formation minerals (e.g., calcium carbonate) and contaminants (e.g., drilling fluid coating the wellbore or penetrated into the formation) introduced into the wellbore/formation during drilling or remedial operations.

For instance, sandstone formations are often treated with a mixture of hydrofluoric acid (HF) at very low injections rates (to avoid fracturing the formation). This acid mixture is often selected because it will dissolve clays (found in drilling mud) as well as the primary constituents of naturally occurring sandstones (e.g., silica, feldspar, indigenous clays, and calcareous material).

Similarly, in carbonate systems, the preferred acid is hydrochloric acid (HCl). Though widely used, hydrochloric acid is known to be ineffective in some of the remedial operations described above. It is an accepted assumption that HCl reacts so quickly with the limestone and dolomite rock that acid penetration into the formation is limited to between a few inches and a few feet. The rate at which the acid is neutralized or “spent” as it comes in contact with the exposed surfaces of the formation may exceed the rate at which it can be forced into the reservoir. It is therefore seen as one of the biggest difficulties in acidizing a hydrocarbon bearing carbonate formation to deliver fresh acid far down to the tip of the created fractures (in fracturing acidizing) or into extended dissolution channels (matrix acidizing). This inability to effectively etch the entire fracture length or creating long dissolution channels (“wormholes”) limits the application of present well acid treatments.

In addition, when a hydrocarbon-containing carbonate formation is injected with acid, e.g., hydrochloric acid), the acid begins to dissolve the carbonate. As acid is pumped into the formation, a dominant channel through the matrix is inevitably created. As additional acid is pumped into the formation, the acid naturally flows along that newly created channel—i.e., along the path of least resistance—and, therefore, leaves the rest of the formation untreated. This is of course undesirable.

The problem is exacerbated by intrinsic heterogeneity with respect to permeability, which is common in many formations—and it occurs in natural fractures in the formation and due high permeability streaks. Again, these regions of heterogeneity attract large amounts of the injected acid, hence keeping the acid from reaching other parts of the formation along the wellbore—where it is actually needed most. Thus, in many cases, a substantial fraction of the productive, oil-bearing intervals within the zone to be treated is not contacted by acid sufficient to penetrate deep into the formation matrix to effectively increase its permeability and therefore its capacity for delivering hydrocarbon to the wellbore.

In view of the problems listed above, many alternatives to the commonly used hydrofluoric and hydrochloric acids have been suggested. Among those seen as most relevant to the present invention are the U.S. Pat. No. 2,863,832 issued to Perrine, the U.S. Pat. No. 3,251,415 issued to Bombardieri et al., the U.S. Pat. No. 3,441,085 issued to Gidley, the U.S. Pat. No. 4,122,896 issued to Scheuerman et al., the U.S. Pat. No. 4,151,879 issued to Thomas, the U.S. Pat. No. 5,979,556 issued to Gallup et al., the U.S. Pat. No. 6,903,054 issued to Fu et al., and the U.S. Pat. No. 7,299,870 issued to Garcia-Lopez De Victoria et al. These patents disclose the use of organic acids, and of delayed acids using precursors and anhydrides of acids. In particular, the U.S. Pat. No. 6,903,054 lists maleic acid within broad group of other possible acids without, however, making any further specific reference to it.

In the view of the above referenced patents it is seen as an object of the present invention to provide novel compositions for and methods of performing acidizing treatments of subterranean reservoirs, particularly carbonate reservoirs.

### SUMMARY OF INVENTION

According to a first aspect, this invention relates to a composition including a mixture of hydrochloric acid (HCl) and a carboxylic acid or a precursor of a carboxylic acid for use in subterranean reservoirs, particularly reservoirs with a large proportion of carbonate rocks. It appears that the carboxylic acid is prevented from dissociating in hydrochloric acid due to the high hydrogen ion concentration which the hydrochloric acid provides. The hydrochloric acid, in turn, reacts fast to dissolve the rock near the wellbore thus creating wide channels which help to reduce the pressure gradient during production. As the hydrochloric acid is spent, its hydrogen ions are depleted and the carboxylic acid begins to dissociate. This is understood to result in further acidizing from the tip of the acid front, thus increasing the penetration of the composition.

The precursor of the said carboxylic acid can be used in place of the carboxylic acid itself in order to further delay the reaction. Using a precursor, an additional hydrolysis reaction, which is typically triggered by the higher temperature in the formation, is required to convert the precursor into the carboxylic acid. All three components, HCl, carboxylic acid, and the precursor of the carboxylic acid, can be mixed into a single composition which reacts in three stages with the formation rock.

In a further aspect of the present invention, there is provided a method of altering the permeability of a subterranean reservoir by the injection of a composition including a mixture of hydrochloric acid (HCl) and a carboxylic acid or a precursor of the carboxylic acid into a subterranean reservoir. The step of altering the permeability includes methods such as: (1) injecting chemicals into the wellbore to react with and dissolve damages (e.g., scales, filtercakes); (2) injecting chemicals through the wellbore and into the formation to react with and dissolve small portions of the formation to create alternative flowpaths for the hydrocarbon; and (3) injecting chemicals through the wellbore and into the formation at pressures sufficient to actually fracture the formation, thereby creating a large flow channel through which hydrocarbon can more readily move from the formation into the wellbore.

In a preferred embodiment of the above aspects of the invention, the carboxylic acid has less than 5 carbon atoms. In another preferred embodiment, the carboxylic acid it is essentially not viscoelastic, such as the acid mixtures described for example in U.S. Pat. No. 6,903,054 cited above. In a further preferred embodiment the composition itself is essentially free of components which have visco-elastic behavior under surface and/or downhole conditions. In a particularly preferred embodiment of the invention, the carboxylic acid is maleic acid (butenedioic acid) or derivates thereof. In another preferred embodiment of this invention, the carboxylic acid is lactic acid.

In another preferred embodiment of the invention, the precursor is maleic anhydride (dihydro-2,5-dioxofuran) or derivatives thereof.

A composition in accordance with a further preferred embodiment of the invention can contain further additives such as inhibitors, demulsifiers and/or thickening agents, each of which are known per se.

A method in accordance with a further preferred embodiment of the invention includes further steps such as injecting cleaning fluids or spacer fluids into the reservoir before and/or after the injection of the composition in accordance with the first aspect of the invention.

These and other aspects of the invention are described in greater detail below making reference to the following drawings.

### BRIEF DESCRIPTION OF THE FIGURES

FIG. 1 is a graph comparing the time profiles of the reaction with calcium carbonate of a composition in accordance with an example of the invention and of hydrochloric acid;

FIG. 2 is a graph comparing the time profiles of the reaction with calcium carbonate of a mixture of maleic acid with hydrochloric acid, of a mixture of maleic anhydrate, and of pure hydrochloric acid, respectively; and

FIG. 3 is a graph comparing the amount of calcium carbonate dissolved by similar amounts of four different mixtures of a carboxylic acid with hydrochloric acid.

### DETAILED DESCRIPTION

In acidizing of a carbonate reservoir, reducing the reaction rate between the injected acid and the rock can be beneficial to the well productivity. A lower reaction rate allows the acid to dissolve rock deeper inside the formation, resulting in an extended effective wellbore diameter and longer wormholes. This applies to both matrix acidizing and fracture acidizing. As mentioned above, hydrochloric acid (HCl) is the most commonly used acid for carbonate acidizing due to its low cost and high dissolving power of carbonate rocks. However, the reaction rate of HCl with carbonate rock is very high. Therefore, HCl frequently needs to be retarded by gelling, emulsifying, or adding surfactants.

Near the wellbore, the total surface area available for production fluid to flow into the well is significantly less than that far away from the wellbore inside the reservoir. As a consequence, the pressure gradient increases dramatically. The ideal stimulation should therefore ideally create a wide channel near the wellbore for reducing the pressure gradient in addition to providing a deep penetrating live or active acid system. Retarded acid systems as known can provide deep penetration but only through relatively narrow channels. To generate wide channels near wellbore capable of reducing the pressure gradient, a high reaction rate is preferred. This means that an ideal stimulation fluid for acidizing in carbonate reservoirs is ideally highly reactive when initially contacting the formation, and then turning into a less reactive composition as it penetrates deeper into the reservoir.

Several tests to be described below show that such ideal behavior can be expected to a certain extent from the compositions as proposed by the present invention.

FIG. 1 compares the reaction between the mixture of 15% hydrochloric acid (HCl) and 15% maleic acid (MEA) and that of pure HCl based on a similar overall dissolving capacity for calcium carbonate. The mixture with its measured points indicated as solid squares takes 120 minutes to complete while approximately the same amount of calcium carbonate is dissolved in less than 30 minutes using 20% HCl (solid circles). The mixture preserves the early high reaction rate for wide channel creation and the total amount of dissolved calcium carbonate. However the time before it is becomes inactive or spent is longer than that of the pure HCl.

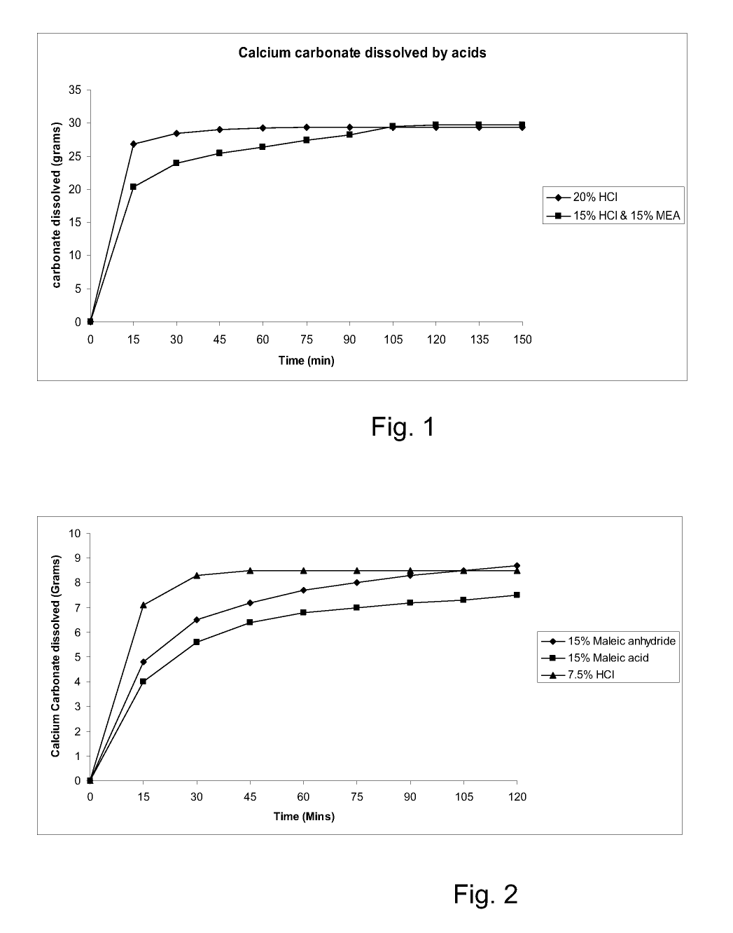

A similar delay is exhibited by a mixture of HCL and the precursor of maleic acid, maleic anhydrate (MAH). A comparison of pure 7.5% HCl (solid triangles), a 15% mixture of equal parts of HCl and MEA (solid diamonds) and a 15% mixture of equal parts of HCL and MAH (solid squares) is shown in FIG. 2. Again, all acids are approximately equal in the total amount of dissolved carbonate as indicated in the abscissa, but the two mixtures display a slower rise and remain reactive for a longer time period.

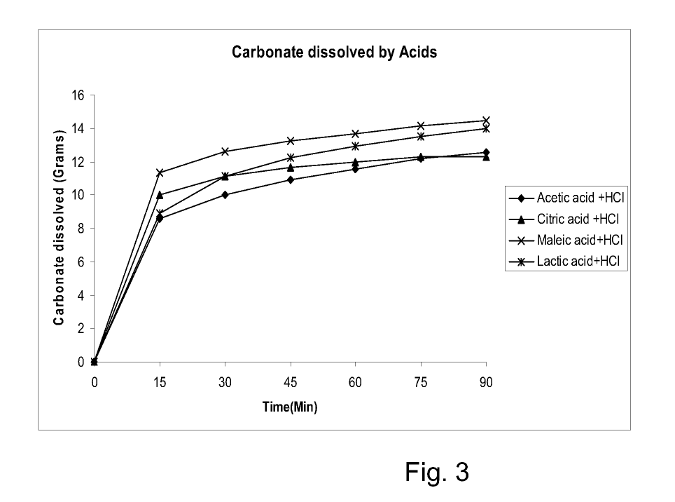

In FIG. 3, the carbonate dissolving properties of four different carboxylic acid mixtures are compared. Each acid is a mixture of 10% by weight of the organic acid and 10% by weight of HCl. The graphs show that maleic acid (top curve) is the most effective composition followed by lactic acid, whereas the two bottom curves of citric acid and acetic acid, respectively, have a lower total reactivity and dissolve less carbonates.

The advantageous properties of the compositions in accordance with the invention can be further demonstrated by comparing the solubility of the reaction products which are formed in the reaction of the acids with the formation rock. The table 1 below lists the solubility of reaction products of various acids with carbonate rock at different temperatures.

TABLE 1

| | | High Temp(g/100 ml |
|---|---|---|
| Solubility of salts | Low Temp(g/100 ml water) | water) |
| Calcium acetate | 37.3 g (0° C.)* | 29.67 g (100° C.)* |
| Calcium formate | 16 g (20° C.)** | 18.07 g (80.5° C.)** |
| Calcium lactate | 2.38 g (10° C.)*** | 3.89 g (24° C.)*** |
| Calcium maleate | 12.8 g (19° C.)**** | 33.5 g (65° C.)**** |
| Calcium citrate | 0.7 g (18° C.)* | 0.84 g (23° C.)* |
| Calcium dihydrogen | 1.5 g (30° C.)* | |
| phosphate | | |
| Calcium malate | 0.5 g (0° C.)* | 1 g (37.5° C.)* |
| Calcium malonate | 0.3 g (0° C.)* | 0.48 g (100° C.)* |
| Calcium succinate | 0.14 g (10° C.)* | 0.65 g (80° C.)* |

It can be seen that the reaction product of maleic acid, calcium maleate, has a very good solubility, particularly at higher temperatures.

In a typical acid treatment of a carbonate reservoir, first a cleaning fluid is pumped from the surface down a well to clean up the exposed surface of the rock and well tubulars. The cleaning is followed with a treatment fluid as per the present invention. The well may then be shut in and allowed to stand for a period of time for the slower acid reaction or acid reactions to run their course. A post-flush fluid, typically a brine solution or an oil, such as diesel, may be injected last.

The exact volume and composition of the treatment fluid is determined by the conditions encountered in the treated formation. The lower limit of the concentration of treatment acid is determined by the amount of substance required to obtain a reasonable change of permeability in the treated formation. The upper limit, if not determined by cost constraints, may be determined by the amount which can be pumped while remaining below the fracturing pressure of the reservoir.

The amount of substance required to be dissolved is determined by the initial permeability of the formation. For a high permeability formation, it is preferred to attempt to create channel profiles with long sections of wide channels starting from the wellbore extending into short sections of narrow channels. Therefore, a higher fraction of a highly reactive acid like HCl is preferred in the mixture. For a low permeability formation, it is preferred to render profiles with short sections of wide channels starting from the wellbore extending into long sections of narrow channels. Therefore, a higher fraction of low reaction rate acid and/or precursor of this acid such as the maleic acid is preferred in the mixture for these types of formations. The typical concentration of the high reaction rate acid component is 3 wt. % to 28% wt. %, and the typical concentration of the low reaction rate acid component and/or precursor is 1 wt. % to 40 wt. %.

What is claimed is:

1. A reservoir treatment fluid, comprising:
a) hydrochloric acid; and
b) a compound forming a carboxylic acid within a well penetrating a subterranean reservoir.

2. A fluid in accordance with claim 1, wherein the carboxylic acid has less than 5 carbon atoms.

3. A fluid in accordance with claim 1, wherein the compound forming the carboxylic acid is lactic acid.

4. A fluid in accordance with claim 1, wherein the compound forming the carboxylic acid is maleic acid.

5. A fluid in accordance with claim 1, wherein the compound forming the carboxylic acid is a precursor compound changing into maleic acid after release into the well.

6. A fluid in accordance with claim 1, wherein the compound forming the carboxylic acid is maleic anhydride.

7. A method of increasing the permeability of a subterranean reservoir comprising the steps of:
injecting into a well penetrating said reservoir a treatment fluid comprising:
a) hydrochloric acid; and
b) a compound forming a carboxylic acid within the well; and
letting both acids react simultaneously with the surface exposed to or in fluid communication with said well.

8. A method in accordance with claim 7, wherein the step of increasing the permeability of a subterranean reservoir includes one of either:
injecting chemicals into the wellbore to react with and dissolve formation damages;
injecting chemicals through the wellbore and into the formation to react with and dissolve small portions of the formation to create alternative flowpaths for the hydrocarbon; or
injecting chemicals through the wellbore and into the formation at pressures sufficient to actually fracture the formation.
